(19) United States
(12) Patent Application Publication
(10) Pub. No.: US 2021/0002430 A1
(43) Pub. Date: Jan. 7, 2021

(54) MOISTURE CURABLE RESIN COMPOSITION AND CURED PRODUCT

(71) Applicant: THREEBOND CO., LTD., Tokyo (JP)

(72) Inventor: Takahito KOSAKA, Tokyo (JP)

(21) Appl. No.: 16/908,094

(22) Filed: Jun. 22, 2020

(30) Foreign Application Priority Data
Jul. 1, 2019 (JP) 2019-122636

(51) Int. Cl. C08G 77/04; C08K 7/26; C08K 5/55; C09J 183/04; C08K 5/092; C08K 3/26

(52) U.S. Cl. CPC C08G 77/04; C08K 7/26; C08K 5/55; C09J 183/04; C08G 2170/00; C08K 3/26; C08K 2003/265; C08G 2190/00; C08K 5/092

(57) ABSTRACT

An object of the present invention is to provide a moisture curable resin composition that is appropriately excellent in workability and is capable of making initial moisture curing properties and moisture curing properties after a storage stability test compatible.

A moisture curable resin composition, containing (A) to (C) components described below, in which the moisture curable resin composition contains 0.03 parts by mass to 0.9 parts by mass of the (C) component with respect to 100 parts by mass of the (A) component.
(A) Component: a curable resin that has a main chain skeleton containing polyoxyalkylene and has a hydrolyzable silyl group
(B) Component: a moisture curing catalyst containing a fluorine-based compound
(C) Component: zeolite having a pore diameter of 5 angstroms to 30 angstroms

### CROSS-REFERENCE TO RELATED APPLICATION

The entire disclosure of Japanese Patent Application No. 2019-122636 filed on Jul. 1, 2019, is incorporated herein by reference in its entirety.

### BACKGROUND

### 1. Technical Field

The present invention relates to a moisture curable resin composition and a cured product.

### 2. Description of Related Arts

From the related art, a moisture curable resin composition containing polyoxyalkylene having a hydrolyzable silyl group and an organic tin compound has been proposed. Such a moisture curable resin composition is subjected to a condensation reaction due to the moisture in the air and is capable of obtaining a rubber-like cured product excellent in an adhesive force with respect to various members such as plastic, a metal, and glass, and thus, can be used in various applications such as an adhesive agent, a pressure-sensitive adhesive agent, a sealing agent, a sealing material, a coating material, and a coating agent.

However, recently, it has been pointed out that the organic tin compound that is used in the moisture curable resin composition has toxicity, and thus, the organic tin compound has been replaced with a non-organic tin compound, from the viewpoint of safety with respect to the environment. Examples of the non-organic tin compound include a titanium-based catalyst, an aluminum-based catalyst, a bismuth-based catalyst, metal neodecanoate, metal octylate, and an amidine compound such as DBU, a halogen compound such as a fluorosilane compound and a boron trifluoride, and the like (refer to JP 2015-038196 A).

### SUMMARY

However, a moisture curable resin composition using a non-organic tin compound disclosed in JP 2015-038196 A is cured by the action of the moisture in the air, and thus, it is difficult to make moisture curing properties and storage stability compatible. Specifically, the moisture curable resin composition immediately after being manufactured has moisture curing properties appropriately excellent in workability, but the moisture curing properties decrease after a storage stability test.

The present invention has been made in consideration of the circumstances described above, and an object thereof is to provide a moisture curable resin composition that is capable of making initial moisture curing properties and moisture curing properties after a storage stability test compatible and does not use an organic tin compound.

The summary of the present invention will be described below.

[1] A moisture curable resin composition, containing (A) to (C) components described below, in which the moisture curable resin composition contains 0.03 parts by mass to 0.9 parts by mass of the (C) component with respect to 100 parts by mass of the (A) component.

(A) Component: a curable resin that has a main chain skeleton containing polyoxyalkylene and has a hydrolyzable silyl group

(B) Component: a moisture curing catalyst containing a fluorine-based compound

(C) Component: zeolite having a pore diameter of 5 angstroms to 30 angstroms

[2] The moisture curable resin composition according to [1], in which a hydrolyzable silyl group of the (A) component is an alkoxysilyl group.

[3] The moisture curable resin composition according to [1] or [2], in which a curable resin of the (A) component has urethane bonding on a main chain.

[4] The moisture curable resin composition according to any one of [1] to [3], in which a viscosity of a curable resin of the (A) component at 25° C. is in a range of 5 Pa·s to 1000 Pa·s.

[5] The moisture curable resin composition according to any one of [1] to [4], in which the moisture curable resin composition does not substantially contain an organic tin compound.

[6] The moisture curable resin composition according to any one of [1] to [5], in which the (B) component is a complex containing boron trifluoride.

[7] The moisture curable resin composition according to any one of [1] to [6], in which the (B) component is a boron trifluoride amine complex.

[8] The moisture curable resin composition according to any one of [1] to [7], in which a content of the (B) component is 0.01 parts by mass to 0.9 parts by mass with respect to 100 parts by mass of the (A) component.

[9] The moisture curable resin composition according to any one of [1] to [8], further containing a silane compound having a hydrolyzable functional group, as a (D) component.

[10] The moisture curable resin composition according to any one of [1] to [9], further containing an inorganic filler, as an (E) component.

[11] The moisture curable resin composition according to any one of [1] to [10], in which the moisture curable resin composition is used as an adhesive agent or a sealing agent.

[12] A cured product in which the moisture curable resin composition according to any one of [1] to [10] is cured.

### DETAILED DESCRIPTION

Hereinafter, one or more embodiments of the present invention will be described, however, the scope of the invention is not limited to the disclosed embodiments.

The present invention provides a moisture curable resin composition that is capable of making initial moisture curing properties appropriately excellent in workability and moisture curing properties after a storage stability test compatible and does not use an organic tin compound. Note that, in the present invention, the “moisture curing properties” mainly indicate surface curing properties due to the moisture, and examples thereof include moisture curing properties that are evaluated by tack-free time described below, and the like.

<(A) Component>

The (A) component that is used in the present invention is not particularly limited insofar as the component is a curable resin that has a main chain skeleton containing polyoxyalkylene and has a hydrolyzable silyl group. The hydrolyzable silyl group of the (A) component is hydrolyzed and forms siloxane bonding, and thus, the (A) component is cross-linked and becomes a cured product. The polyoxyalkylene is not particularly limited, and examples thereof include polyoxyethylene, polyoxypropylene, polyoxybutylene, polyoxytetramethylene, and the like. Among them, polyoxypropylene is preferable from the viewpoint of excellent moisture curing properties and excellent adhesiveness and of obtaining a rubber-like cured product. In addition, it is preferable that polyoxyalkylene has urethane bonding or urea bonding on a main chain from the viewpoint of further making initial moisture curing properties and moisture curing properties after a storage stability test compatible. In addition, it is particularly preferable that the (A) component is a curable resin that has a main chain skeleton containing polypropylene glycol and has a hydrolyzable silyl group on both terminals through urethane bonding or urea bonding, from the viewpoint of making the initial moisture curing properties and the moisture curing properties after a storage stability test compatible and of an excellent adhesive force with respect to various members such as a metal or plastic. In addition, it is preferable that a (meth)acrylic resin is further contained as the (A) component, in addition to a curable resin that has a main chain skeleton containing polyoxyalkylene and has a hydrolyzable silyl group. That is, the component (A) is preferably a curable resin containing a (meth) acrylic resin as a mixture. In a case where the (A) component contains the (meth)acrylic resin, an effect that an adhesive force with respect to various adherends is excellent can be obtained.

In the hydrolyzable silyl group of the (A) component, 1 to 3 hydrolyzable groups are bonded to a silicon atom, preferred examples of the hydrolyzable group include a halogen atom, an alkoxy group, an acyl oxide group, a ketoximate group, an amino group, an amide group, an aminooxy group, an alkenyl oxide group, and the like, and an alkoxy group that does not generate a harmful by-product in a reaction is particularly preferable.

Examples of the alkoxy group include a methoxy group, an ethoxy group, a propyloxy group, an isopropyloxy group, a butoxy group, a tert-butoxy group, a phenoxy group, a benzyloxy group, and the like, and among them, a methoxy group and an ethoxy group are preferable. The alkoxy groups may be the same type, or different types of alkoxy groups may be combined.

Examples of an alkoxysilyl group in which an alkoxy group is bonded to a silicon atom include a trialkoxysilyl group such as a trimethoxysilyl group, a triethoxysilyl group, a triisopropoxysilyl group, and a triphenoxysilyl group; a dialkoxysilyl group such as a methyl dimethoxysilyl group and a methyl diethoxysilyl group; and a monoalkoxysilyl group such as a dimethyl methoxysilyl group and a dimethyl ethoxysilyl group. Among them, a dialkoxysilyl group and a trialkoxysilyl group are preferable, and a trialkoxysilyl group is particularly preferable. A plurality of alkoxysilyl groups may be used by being combined.

Examples of the curable resin that has the main chain skeleton containing polyoxyalkylene and has a hydrolyzable silyl group include S-203, S-303, S-903, and the like as MS polymer manufactured by KANEKA CORPORATION), SAT-200, SAT-350, MA-403, MA-447, and the like as Silyl polymer manufactured by KANEKA CORPORATION, EXCESTAR ESS-2410, EXCESTAR ESS-2420, and EXCESTAR ESS-3630 manufactured by Asahi Glass Co., Ltd., and the like.

As a manufacturing method of the curable resin that has the main chain skeleton containing polyoxyalkylene (preferably polypropylene glycol) and has a hydrolyzable silyl group on both terminals through the urethane bonding or the urea bonding, for example, the curable resin can be obtained by reacting polyoxyalkylene polyol, polyisocyanate, and a silane compound having an amino group and an alkoxy group with each other.

Specifically, examples of the polyoxyalkylene polyol include polyethylene glycol, polypropylene glycol, polytrimethylene glycol, polytetramethylene glycol, and the like. In addition, examples of the polyisocyanate include xylylene diisocyanate, isohorone diisocyanate, methylene diphenyl diisocyanate, toluylene diisocyanate, and the like. In addition, examples of the silane compound having an amino group and an alkoxy group include N-2-(aminoethyl)-3-aminopropyl trimethoxysilane, N-2-(aminoethyl)-3-aminopropyl methyl dimethoxysilane, N-2-(aminoethyl)-3-aminopropyl methyl trimethoxysilane, N-2-(aminoethyl)-3-aminopropyl methyl triethoxysilane, 3-aminopropyl trimethoxysilane, 3-aminopropyl triethoxysilane, N-phenyl-3-aminopropyl trimethoxysilane, and the like.

A number average molecular weight of polyoxyalkylene polyol contained in the (A) component is not particularly limited, but is preferably 500 to 500,000, is more preferably 1000 to 100,000, and is even more preferably 2000 to 50,000. By setting the number average molecular weight of polyoxyalkylene polyol to be in the range described above, the effects of the present invention are further exhibited.

The curable resin having a main chain skeleton containing polyoxyalkylene and having a hydrolyzable silyl group has preferably a component derived from (meth) acrylate in a molecule. In this case, it is possible to obtain the effect that the adhesive strength to various adherends is excellent. In the curable resin, the component derived from (meth) acrylate is more preferably contained via urethane bonding or urea bonding with a main chain skeleton containing polyoxyalkylene. In a preferred embodiment, the curable resin as the component (A) has a main chain skeleton containing polyoxyalkylene, has a hydrolyzable silyl group on both terminals through urethane bonding or urea bonding, and has a component derived from (meth) acrylate through urethane bonding or urea bonding with a main chain skeleton containing polyoxyalkylene. Examples of a manufacturing method of such curable resin (the curable resin as the component (A) has a main chain skeleton containing polyoxyalkylene, has a hydrolyzable silyl group on both terminals through urethane bonding or urea bonding, and has a component derived from (meth) acrylate through urethane bonding or urea bonding with a main chain skeleton containing polyoxyalkylene) include a method of introducing the component derived from (meth)acrylate into a silane compound. The amino group (a primary amino group) of the silane compound having an amino group and an alkoxy group reacts with a monomer configuring the (meth)acrylic resin described below, and thus, a silane compound is obtained in which the silane compound has the component derived from (meth)acrylate, a secondary amino group, and an alkoxy group. The silane compound is reacted with polyoxyalkylene polyol and polyisocyanate, and thus, it is possible to obtain above-mentioned curable resin (the curable resin as the component (A) has a main chain skeleton containing polyoxyalkylene, has a hydrolyzable silyl group on both terminals through urethane bonding or urea bonding, and has a component derived from (meth) acrylate through urethane bonding or urea bonding with a main chain skeleton containing polyoxyalkylene).

The (meth)acrylic resin can be obtained by performing various polymerization methods with respect to various monomers, and the method thereof is not particularly limited, but a radical polymerization method is preferable from the viewpoint of the ease of reaction control, and in radical polymerization, living radical polymerization is preferable. In addition, a manufacturing method of a polymer using the living radical polymerization is not particularly limited, and examples thereof include a reversible additional cleavage chain transfer polymerization (RAFT) method, an atom transfer radical polymerization (ATRP) method, and the like.

A monomer configuring the (meth)acrylic resin is not particularly limited, and various monomers can be used. Specifically, examples of the monomer include (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethyl hexyl (meth)acrylate, nonyl (meth)acrylate, decyl (meth)acrylate, dodecyl (meth)acrylate, phenyl (meth)acrylate, toluyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(methacryloyloxypropyl) trimethoxysilane, an ethylene oxide adduct of (meth)acrylic acid, trifluoromethyl methyl (meth)acrylate, 2-trifluoromethyl ethyl (meth)acrylate, 2-perfluoroethyl ethyl (meth)acrylate, 2-perfluoroethyl-2-perfluorobutyl ethyl (meth)acrylate, 2-perfluoroethyl (meth)acrylate, perfluoromethyl (meth)acrylate, diperfluoromethyl methyl (meth)acrylate, 2-perfluoromethyl-2-perfluoroethyl methyl (meth)acrylate, 2-perfluorohexyl ethyl (meth)acrylate, 2-perfluorodecyl ethyl (meth)acrylate, 2-perfluorohexadecyl ethyl (meth)acrylate, and the like, but are not limited thereto. In the present invention, a monomer can be polymerized by being selected from the monomers, and it is preferable to select a (meth)acrylic monomer having a hydrocarbon group.

As a manufacturing method of a curable resin containing a (meth)acrylic resin as a mixture, for example, the curable resin can be obtained by adjusting the amount of monomer configuring the (meth)acrylic resin or a reaction condition, at the time of introducing a component derived from (meth)acrylate into a silane compound.

In the present invention, the viscosity of the (A) component at 25° C. is not particularly limited, and for example, is in a range of 5 Pa·s to 1000 Pa·s, is preferably in a range of 30 Pa·s to 500 Pa·s, and more preferably in a range of 50 Pa·s to 300 Pa·s, from the viewpoint of workability or the like. Note that, unless otherwise noted, the viscosity was measured by using a cone plate type viscosity meter, and a viscosity at 25° C. was measured on the basis of JIS K 6833-1:2008.

<(B) Component>

A moisture curing catalyst containing a fluorine-based compound of the (B) component to be used in the present invention functions as a catalyst that accelerates a condensation reaction of the (A) component. The present invention has a remarkable effect of enabling the initial moisture curing properties and the moisture curing properties after a storage stability test to be compatible while maintaining an adhesive force with respect to various members such as plastic and a metal, by selecting the (B) component among a plurality of non-organic tin compounds, and by combining the (B) component with the other components of the present invention. Examples of the (B) component include a fluorosilane compound, a complex, and a complex containing boron trifluoride, and the like. The fluorosilane compound is not particularly limited, and examples thereof include trimethyl fluorosilane, triethyl fluorosilane, diethyl difluorosilane, methyl trifluorosilane, trimethoxyfluorosilane, triethoxyfluorosilane, diethoxydifluorosilane, ethoxytrifluorosilane, and the like. In addition, examples of the complex include an amine complex, an alcohol complex, an ether complex, and the like, and among them, an amine complex is preferable. Specifically, examples of the amine complex include monoethyl amine, triethyl amine, pyridine, piperidine, aniline, morpholine, cyclohexyl amine, monoethanol amine, diethanol amine, triethanol amine, and the like.

The complex containing boron trifluoride is not particularly limited, and examples thereof include boron trifluoride amine complex such as boron trifluoride monoethyl amine, boron trifluoride triethyl amine, boron trifluoride aniline, boron trifluoride piperidine, and the like. Among them, boron trifluoride amine complex such as boron trifluoride monoethyl amine and boron trifluoride triethyl amine is preferable. Note that, the complex containing boron trifluoride is available from Tokyo Chemical Industry Co., Ltd., STELLA CHEMIFA CORPORATION, and the like.

A content of the (B) component is preferably 0.01 parts by mass to 0.9 parts by mass, is more preferably 0.05 parts by mass to 0.7 parts by mass, and is particularly preferably 0.1 parts by mass to 0.5 parts by mass, with respect to 100 parts by mass of the (A) component. By setting the content of the (B) component to be in the range described above, a remarkable effect of enabling the initial moisture curing properties and the moisture curing properties after a storage stability test to be compatible is obtained.

<(C) Component>

A (C) component of the present invention is zeolite having a pore diameter of 5 angstroms to 30 angstroms, and has an effect of enabling the initial moisture curing properties and the moisture curing properties after a storage stability test to be compatible while maintaining an adhesive force with respect to various members such as plastic and a metal, by being combined with the other components of the present invention. Examples of the zeolite include synthetic zeolite or natural zeolite. Examples of the synthetic zeolite include crystalline aluminosilicate, and the like. The pore diameter of the (C) component of the present invention is more preferably 6 angstroms to 20 angstroms, and is 8 angstroms to 15 angstroms. The pore diameter is uniformly set from a crystalline structure, and all pore diameters are homogeneous. For example, crystalline zeolite obtained by heating and removing water of Na₈₆[(AlO₂)₈₆(SiO₂)₁₀₆].276H₂O uniformly has a pore diameter of 13 angstroms, and Molecular Sieve 13X, manufactured by Union Showa K.K., and the like are exemplified as a commercially available product. Crystalline zeolite obtained by heating and removing water of Na₁₂[(AlO₂)₈₆(SiO₂)₁₀₆]·27H₂O uniformly has a pore diameter of 4 angstroms, and Molecular Sieve 4A, manufactured by Union Showa K.K., and the like are exemplified as a commercially available product. A commercially available product of the (C) component is not particularly limited, and examples thereof include synthetic zeolite, manufactured by Tosoh Corporation, and the like, in addition to Molecular Sieve 13X, manufactured by Union Showa K.K., but are not limited thereto. Note that 1 angstrom (Å)=0.1 nm.

A content of the (C) component is preferably in a range of 0.03 parts by mass to 0.9 parts by mass, is more preferably in a range of 0.05 parts by mass to 0.7 parts by mass, is still more preferably in a range of 0.1 parts by mass to 0.5 parts by mass, and is particularly preferably in range of 0.1 parts by mass to 0.22 parts by mass, with respect to 100 parts by mass of the (A) component. By setting the content of the (C) component to be in the range described above, a remarkable effect of enabling the initial moisture curing properties and the moisture curing properties after a storage stability test to be compatible is obtained.

<(D) Component>

Further, a silane compound having a hydrolyzable functional group can be added to the moisture curable resin composition of the present invention, as a (D) component. According to the (D) component, the effect of enabling the initial moisture curing properties and the moisture curing properties after a storage stability test to be compatible is further obtained.

The (D) component is not particularly limited, and examples thereof include tetramethoxysilane, tetraethoxysilane, methyl trimethoxysilane, dimethyl dimethoxysilane, methyl triethoxysilane, dimethyl diethoxysilane, phenyl trimethoxysilane, diphenyl dimethoxysilane, phenyl triethoxysilane, N-2-(aminoethyl)-3-aminopropyl trimethoxysilane, N-2-(aminoethyl)-3-aminopropyl methyl dimethoxysilane, N-2-(aminoethyl)-3-aminopropyl methyl trimethoxysilane, N-2-(aminoethyl)-3-aminopropyl methyl triethoxysilane, 3-aminopropyl trimethoxysilane, 3-aminopropyl triethoxysilane, N-phenyl-3-aminopropyl trimethoxysilane, 3-methacryloxypropyl methyl dimethoxysilane, 3-methacryloxypropyl trimethoxysilane, 3-methacryloxypropyl methyl diethoxysilane, 3-methacryloxypropyl triethoxysilane, 3-acryloxypropyl trimethoxysilane, methacryloxyoctyl trimethoxysilane, vinyl trimethoxysilane, vinyl triethoxysilane, vinyl-tris(β-methoxyethoxy) silane, γ-chloropropyl trimethoxysilane, β-(3,4-epoxy cyclohexyl) ethyl trimethoxysilane, γ-glycidoxypropyl trimethoxysilane, γ-mercaptopropyl trimethoxysilane, and the like. Among them, methyl trimethoxysilane, dimethyl dimethoxysilane, methyl triethoxysilane, dimethyl diethoxysilane, phenyl trimethoxysilane, diphenyl dimethoxysilane, phenyl triethoxysilane, N-2-(aminoethyl)-3-aminopropyl trimethoxysilane, N-2-(aminoethyl)-3-aminopropyl methyl dimethoxysilane, N-2-(aminoethyl)-3-aminopropyl methyl trimethoxysilane, N-2-(aminoethyl)-3-aminopropyl methyl triethoxysilane, 3-aminopropyl trimethoxysilane, 3-aminopropyl triethoxysilane, N-phenyl-3-aminopropyl trimethoxysilane, vinyl trimethoxysilane, vinyl triethoxysilane, and vinyl-tris(β-methoxyethoxy) silane are particularly preferable from the viewpoint of excellent moisture curing properties after a storage stability test.

The content of the (D) component is preferably in a range of 0.3 parts by mass to 30 parts by mass, is more preferably in a range of 0.5 parts by mass to 20 parts by mass, and is particularly preferably in a range of 0.7 parts by mass to 15 parts by mass, with respect to 100 parts by mass of the (A) component. According to the range described above, the moisture curing properties after a storage stability test are more excellent.

<(E) Component>

Further, an inorganic filler can be added to the moisture curable resin composition of the present invention, as an (E) component. According to the (E) component, an effect that it is possible to make the initial moisture curing properties and the moisture curing properties after a storage stability test compatible and an adhesive force with respect to various members such as a metal or plastic is excellent is further obtained. The inorganic filler is not particularly limited, and examples thereof include glass, fumed silica, alumina, mica, ceramic, a silicone rubber powder, calcium carbonate, aluminum hydroxide, aluminum nitride, a carbon powder, kaolin clay, dry clay mineral, dry diatomaceous earth, and the like, and among them, fumed silica, mica, calcium carbonate, aluminum hydroxide, and aluminum nitride are preferable. Note that, the (C) component of the present invention is excluded from the (E) component.

The fumed silica can be added in order to improve coating workability of the moisture curable resin composition, or the hardness, an elongation rate, and a tensile strength of the cured product. Preferably, fumed silica subjected to a hydrophobing treatment with olganochlorosilanes, polyolganosiloxane, hexamethyl disilazane, and the like can be used. Specific examples of fumed silica include a commercially available product such as AEROSIL R974, AEROSIL R972, AEROSIL R972V, AEROSIL R972CF, AEROSIL R805, AEROSIL R812, AEROSIL R812S, AEROSIL R816, AEROSIL R8200, AEROSIL RY200, AEROSIL RX200, AEROSIL RY200S, and AEROSIL R202 (Product Name, manufactured by NIPPON AEROSIL CO., LTD.).

A content of the (E) component is not particularly limited, and for example, is in a range of 0.1 parts by mass to 500 parts by mass, is more preferably in a range of 0.3 parts by mass to 300 parts by mass, and is particularly preferably in a range of 0.5 parts by mass to 150 parts by mass, with respect to 100 parts by mass of the (A) component. According to the range described above, the effect that it is possible to make the initial moisture curing properties and the moisture curing properties after a storage stability test compatible and an adhesive force with respect to various members such as a metal or plastic is excellent is further obtained.

<Arbitrary Component>

An additive such as a plasticizer, various elastomers such as a styrene-based copolymer, a filler of an organic powder, a preservation stabilizer, an antioxidant, a light stabilizer, a plasticizer, a pigment, a flame retarder, and a surfactant can be used with respect to the moisture curable resin composition of the present invention, within a range not impairing the object of the present invention.

A plasticizer can be added to the moisture curable resin composition of the present invention. By adding the plasticizer, it is possible to adjust mechanical properties such as the viscosity of the moisture curable resin composition, and the tensile strength and the stretch of the cured product. The plasticizer is not particularly limited, and examples thereof include dibutyl phthalate, diheptyl phthalate, di(2-ethyl hexyl) phthalate, butyl benzyl phthalate, butyl oleate, diethylene glycol dibenzoate, triethylene glycol dibenzoate, pentaerythritol ester, polyethylene glycol, polypropylene glycol, polytetramethylene glycol, and the like. In addition, a polyester-based plasticizer and the like, obtained from a dibasic acid such as a sebacic acid, an adipic acid, an azelaic acid, and a phthalic acid, and dihydric alcohol such as ethylene glycol, diethylene glycol, triethylene glycol, propylene glycol, and dipropylene glycol, are exemplified. The plasticizers may be independently used, or two or more types thereof may be used together.

A styrene-based copolymer may be added with respect to the present invention, in order to adjust rubber physical properties of the cured product. The styrene-based copolymer is not particularly limited, and examples thereof include a styrene-butadiene copolymer, a styrene-isoprene copolymer (SIP), a styrene-butadiene copolymer (SB), a styrene-ethylene-butylene-styrene copolymer (SEBS), a styrene-isobutylene-styrene copolymer (SIBS), an acrylonitrile-styrene copolymer (AS), a styrene-butadiene-acrylonitrile copolymer (ABS), and the like.

Examples of a filler of an organic powder include polyethylene, polypropylene, nylon, cross-linked acryl, cross-linked polystyrene, polyester, polyvinyl alcohol, polyvinyl butyral, polycarbonate, and the like. It is preferable that a content of the organic powder is approximately 0.1 parts by mass to 100 parts by mass, with respect to 100 parts by mass of the (A) component.

A preservation stabilizer may be added to the present invention. A radical absorption agent such as benzoquinone, hydroquinone, and hydroquinone monomethyl ether, a metal chelator such as an ethylene diamine tetra-acetic acid or a 2-sodium salt thereof, an oxalic acid, acetyl acetone, and o-aminophenol, and the like can also be added as the preservation stabilizer.

An antioxidant may be added to the present invention. Examples of the antioxidant include a quinone-based compound such as β-naphthoquinone, 2-methoxy-1,4-naphthoquinone, methyl hydroquinone, hydroquinone, hydroquinone monomethyl ether, mono-tert-butyl hydroquinone, 2,5-di-tert-butyl hydroquinone, p-benzoquinone, 2,5-diphenyl-p-benzoquinone, and 2,5-di-tert-butyl-p-benzoquinone; phenols such as phenothiazine, 2,2-methylene-bis(4-methyl-6-tert-butyl phenol), catechol, tert-butyl catechol, 2-butyl-4-hydroxyanisole, 2,6-di-tert-butyl-p-cresol, 2-tert-butyl-6-(3-tert-butyl-2-hydroxy-5-methyl benzyl)-4-methyl phenyl acrylate, 2-[1-(2-hydroxy-3,5-di-tert-pentyl phenyl) ethyl]-4,6-di-tert-pentyl phenyl acrylate, 4,4′-butylidene bis(6-tert-butyl-3-methyl phenol), 4,4′-thiobis(6-tert-butyl-3-methyl phenol), 3,9-bis[2-[3-(3-tert-butyl-4-hydroxy-5-methyl phenyl) propionyloxy]-1,1-dimethyl ethyl]-2,4,8,10-tetraoxaspiro[5,5] undecane, pentaerythritol tetrakis[3-(3,5-di-tert-butyl-4-hydroxyphenyl) propionate], thiodiethylene bis[3-(3,5-di-tert-butyl-4-hydroxyphenyl) propionate], octadecyl-3-(3,5-di-tert-butyl-4-hydroxyphenyl) propionate, N,N′-hexane-1,6-diyl bis[3-(3,5-di-tert-butyl-4-hydroxyphenyl) propion amide], benzene propanoate, 3,5-bis(1,1-dimethyl ethyl)-4-hydroxy, C7-C9 side-chain alkyl ester, 2,4-dimethyl-6-(1-methyl pentadecyl) phenol, diethyl [[3,5-bis(1,1-dimethyl ethyl)-4-hydroxyphenyl] methyl] phosphonate, 3,3′,3″,5,5′,5″-hexa-tert-butyl-a,a′,a″-(mesitylene-2,4,6-tolyl) tri-p-cresol, calcium diethyl bis[[3,5-bis(1,1-dimethyl ethyl)-4-hydroxyphenyl] methyl] phosphonate, 4,6-bis(octyl thiomethyl)-o-cresol, ethylene bis(oxyethylene) bis[3-(5-tert-butyl-4-hydroxy-m-tolyl) propionate], hexamethylene bis[3-(3,5-di-tert-butyl-4-hydroxyphenyl) propionate, 1,3,5-tris(3,5-di-tert-butyl-4-hydroxybenzyl)-1,3,5-triazine-2,4,6(1H,3H,5H)-trione, 1,3,5-tris[(4-tert-butyl-3-hydroxy-2,6-xylyl) methyl]-1,3,5-triazine-2,4,6(1H,3H,5H)-trione, a reaction product of N-phenyl benzene amine and 2,4,6-trimethyl pentene, 2,6-di-tert-butyl-4-(4,6-bis(octyl thio)-1,3,5-triazine-2-yl amino)phenol, a picric acid, and a citric acid; a phosphorus-based compound such as tris(2,4-di-tert-butyl phenyl) phosphite, tris[2-[[2,4,8,10-tetra-tert-butyl dibenzo[d,f][1,3,2]dioxaphosphephine-6-yl]oxy]ethyl] amine, bis(2,4-di-tert-butyl phenyl) pentaerythritol diphosphite, bis[2,4-bis(1,1-dimethyl ethyl)-6-methyl phenyl] ethyl ester phosphite, tetrakis(2,4-di-tert-butyl phenyl) [1,1-bisphenyl]-4,4′-diyl bisphosphonite, and 6-[3-(3-tert-butyl-4-hydroxy-5-methyl phenyl) propoxy]-2,4,8,10-tetra-tert-butyl dibenz[d, f][1,3,2]dioxaphosphephine; a sulfur-based compound such as dilauryl 3,3′-thiodipropionate, dimyristyl 3,3′-thiodipropionate, distearyl 3,3′-thiodipropionate, pentaerythrityl tetrakis(3-lauryl thiopropionate), and 2-mercaptobenzimidazole; an amine-based compound such as phenothiazine; a lactone-based compound; a vitamin E-based compound, and the like. Among them, a phenol-based compound is preferable

A light stabilizer may be added to the present invention. Examples of the light stabilizer include bis(2,2,6,6-tetramethyl-4-piperidyl) sebacate, bis(1,2,2,6,6-pentamethyl-4-piperidyl) sebacate, 4-benzoyloxy-2,2,6,6-tetramethyl piperidine, 1-[2-[3-(3,5-di-tert-butyl-4-hydroxyphenyl) propionyloxy]ethyl]-4-[3-(3,5-di-tert-butyl-4-hydroxyphenyl) propionyloxy]-2,2,6,6-tetramethyl piperidine, 1,2,2,6,6-pentamethyl-4-piperidinyl-methacrylate, bis(1,2,2,6,6-pentamethyl-4-piperidinyl) [[3,5-bis(1,1-dimethyl ethyl)-4-hydroxyphenyl] methyl] butyl malonate, decanedioic acid bis(2,2,6,6-tetramethyl-1(octyloxy)-4-piperidinyl) ester, a reaction product of 1,1-dimethyl ethyl hydroperoxide and octane, N,N′,N″,N′″-tetrakis-(4,6-bis-(butyl-(N-methyl-2,2,6,6-tetramethyl piperidine-4-yl) amino)-triazine-2-yl)-4,7-diazadecane-1,10-diamine, a polycondensation of dibutyl amine.1,3,5-triazine.N,N′-bis(2,2,6,6-tetramethyl-4-piperidyl-1,6-hexamethylene diamine and N-(2,2,6,6-tetramethyl-4-piperidyl) butyl amine, poly[[6-(1,1,3,3-tetramethyl butyl) amino-1,3,5-triazine-2,4-diyl] [(2,2,6,6-tetramethyl-4-piperidyl) imino]hexamethylene [(2,2,6,6-tetramethyl-4-piperidyl) imino]], a polymer of dimethyl succinate and 4-hydroxy-2,2,6,6-tetramethyl-1-piperidine ethanol, 2,2,4,4-tetramethyl-20-(β-lauryloxycarbonyl) ethyl-7-oxa-3,20-diazadispiro[5.1.11.2]heneicosan-21-one, β-alanine, N,-(2,2,6,6-tetramethyl-4-piperidinyl)-dodecyl ester/tetradecyl ester, N-acetyl-3-dodecyl-1-(2,2,6,6-tetramethyl-4-piperidinyl)pyrrolidin-2,5-dione, 2,2,4,4-tetramethyl-7-oxa-3,20-diazadispiro[5,1,11,2]heneicosan-21-one, 2,2,4,4-tetramethyl-21-oxa-3,20-diazadicyclo-[5,1,11,2]-heneicosane-20-propanoate dodecyl ester/tetradecyl ester, a propane dioic acid, [(4-methoxyphenyl)-methylene]-bis(1,2,2,6,6-pentamethyl-4-piperidinyl) ester, higher fatty acid ester of 2,2,6,6-tetramethyl-4-piperidinol, 1,3-benzene dicarboxyamide, a hindered amine-based such as N,N′-bis(2,2,6,6-tetramethyl-4-piperidinyl); a benzophenone-based compound such as octabenzone; a benzotriazole-based compound such as 2-(2H-benzotriazole-2-yl)-4-(1,1,3,3-tetramethyl butyl) phenol, 2-(2-hydroxy-5-methyl phenyl) benzotriazole, 2-[2-hydroxy-3-(3,4,5,6-tetrahydrophthalimide-methyl)-5-methyl phenyl] benzotriazole, 2-(3-tert-butyl-2-hydroxy-5-methyl phenyl)-5-chlorobenzotriazole, 2-(2-hydroxy-3,5-di-tert-pentyl phenyl) benzotriazole, a reaction product of methyl 3-(3-(2H-benzotriazole-2-yl)-5-tert-butyl-4-hydroxyphenyl) propionate and polyethylene glycol, and 2-(2H-benzotriazole-2-yl)-6-dodecyl-4-methyl phenol; a benzoate-based compound such as 2,4-di-tert-butyl phenyl-3,5-di-tert-butyl-4-hydroxybenzoate; a triazine-based compound such as 2-(4,6-diphenyl-1,3,5-triazine-2-yl)-5-[(hexyl)oxy]phenol, and the like. A hindered amine-based compound is particularly preferable.

The moisture curable resin composition of the present invention does not substantially contain an organic tin compound in the composition. Here, not substantially containing is not particularly limited, and for example, indicates that the content of the organic tin compound is less than or equal to 0.5 parts by mass with respect to 100 parts by mass of the (A) component. The content of the organic tin compound is preferably less than or equal to 0.3 parts by mass, and is particularly preferably less than or equal to 0.03 parts by mass, with respect to 100 parts by mass of the (A) component.

The moisture curable resin composition of the present invention can be manufactured by a known method of the related art. For example, a predetermined amount of (A) component to a predetermined amount of (C) component are added and are mixed by using a mixing unit such as a mixer, at a temperature of preferably 10° C. to 70° C. for preferably 0.1 hours to 5 hours, and thus, the moisture curable resin composition can be manufactured. In addition, it is preferable that the moisture curable resin composition is manufactured in a light shielding environment.

<Coating Method>

A known method of a sealing agent or an adhesive agent is used as a method of coating an adherend with the moisture curable resin composition of the present invention. For example, it is possible to use a method using an automatic coating machine, such as dispensing, spray, ink jet, screen printing, gravure printing, dipping, and spin coating. Note that, it is preferable that the moisture curable resin composition of the present invention is a liquid at 25° C., from the viewpoint of handleability.

<Cured Product>

The cured product of the present invention is obtained by curing the moisture curable resin composition of the present invention with the moisture. Note that, in the present invention, “initial moisture curing properties appropriately excellent in workability” indicate that in a case where the moisture curing is excessively fast, the moisture curable resin composition is cured before being pasted, and thus, the workability is degraded, and in a case where the moisture curing is excessively slow, a curing time is slow, and thus, the workability is degraded. Note that, the moisture curing properties mainly indicate surface curing properties due to the moisture, and are moisture curing properties that are evaluated by tack-free time described below. For this reason, specifically, the “initial moisture curing properties appropriately excellent in the workability” are different in accordance with the application of the moisture curable resin composition, and for example, indicate initial moisture curing properties when a tack-free time is in a range of longer than or equal to 3 minutes and shorter than 15 minutes. The tack-free time is a value that is measured on the basis of a tack-free test in JIS A 1439:****, in an environment of 23° C. and 50% RH.

<Application>

Examples of an application in which the moisture curable resin composition or the cured product of the present invention can be preferably used include a sealing agent, an adhesive agent, a coating agent, a casting agent, a potting agent, and the like. Note that, it is preferable that the moisture curable resin composition of the present invention is a liquid at 25° C. at the time of being used in such an application.

In the field of an automobile and a transport aircraft, the moisture curable resin composition and the cured product of the present invention can be used in the adhesion, the sealing, a coating material, and the like of a switch portion, a headlamp, parts in an engine, electrical parts, a driving engine, a brake oil tank, and the like in an automobile. In addition, in a flat panel display, the moisture curable resin composition and the cured product of the present invention can be used in the adhesion, the sealing, and the like of a liquid crystal display, an organic electroluminescence, a light emitting diode display device, and a field-emission display. The moisture curable resin composition and the cured product of the present invention can be also used in the adhesion, the sealing, and the like of an electronic mobile device such as a mobile phone and a multifunctional mobile phone. In the recording field, the moisture curable resin composition and the cured product of the present invention can be used in the adhesion, the sealing, and the like of a CD, a DVD, an MD, a pickup lens, a hard disk periphery (a member for a spindle motor, a member for a magnetic head actuator, and the like), a Blu-ray Disc, and the like. In the field of a battery, the moisture curable resin composition and the cured product of the present invention can be used in the adhesion, the sealing, a coating material, and the like of a Li battery, a manganese battery, an alkali battery, a nickel-based battery, a fuel battery, a silicon-based solar battery, a dye-sensitised solar battery, an organic solar battery, and the like. In the field of an optical part, the moisture curable resin composition and the cured product of the present invention can be used in the adhesion, the sealing, and the like of an optical fiber material of an optical switch periphery and an optical connector periphery, optical passive parts, optical circuit parts, an opto-electronic integrated circuit periphery, and the like in an optical communication system. In addition, the field of an optical apparatus, the moisture curable resin composition and the cured product of the present invention can be used in the adhesion, the sealing, and the like of a lens material, a finder prism, a target prism, a finder cover, a light-receiving sensor unit, a photographing lens, and the like in a still camera. In addition, a conductive adhesive agent, an anisotropic conductive adhesive agent, a thermal conductive resin, a flame retardance imparting adhesive agent, and the like can be exemplified as other applications.

### EXAMPLES

Hereinafter, the present invention will be described in more detail by using Examples, but the present invention is not limited to Examples. Note that, all Examples and Comparative Examples described below do not substantially contain an organic tin compound.

### Synthesis Example of (a1) Component

222 parts by mass of N-(2-aminoethyl)-3-aminopropyl trimethoxysilane and 172 parts by mass of methyl acrylate were put in a synthetic reaction container, and were reacted at 50° C. for 7 days while being stirred and mixed in a nitrogen atmosphere, and thus, a silane compound A having a trimethoxysilyl group and a secondary amino group in the molecules was obtained.

On the other hand, 100 parts by mass of polyoxypropylene polyol having a number average molecular weight of 10,000 and 4.8 parts by mass of isohorone diisocyanate were put to another reaction container, and were reacted at 90° C. for 8 hours while being stirred and mixed with 0.0005 parts by mass of tris(acetyl acetonato)indium in a nitrogen atmosphere, and thus, a polyoxyalkylene resin having an isocyanate group in the molecules was obtained. After that, 8.9 parts by mass of the silane compound A was added and was reacted at 90° C. for 2 hours while being stirred and mixed in a nitrogen atmosphere, and after that, unreacted components were removed under reduced pressure, and thus, a curable resin (a1) that has a main chain skeleton containing polypropylene glycol and has a trimethoxysilyl group on both terminals through urethane bonding was obtained. Note that, the viscosity of (a1) at 25° C. was 150 Pa·s.

<Preparation of Moisture Curable Resin Composition>

### Example 1

100 parts by mass of a curable resin that has the main chain skeleton of the (a1) component, containing polypropylene glycol, and has a trimethoxysilyl group on both terminals through urethane bonding, as an (A) component of the present invention,

0.2 parts by mass of zeolite (Molecular Sieve 13X, manufactured by Union Showa K.K.) having a pore diameter of 13 angstroms of a (c1) component, as a (C) component,

100 parts by mass of calcium carbonate of an (e1) component, as an (E) component, and

20 parts by mass of bis(2-ethyl hexyl) sebacate, as a plasticizer, were added and

were mixed by a planetary mixer at 25° C. for 60 minutes in the environment, and

after that, 0.16 parts by mass of boron trifluoride monoethyl amine (a reagent) of a (b1) component, as a (B) component, and 5 parts by mass of 3-aminopropyl trimethoxysilane of a (d1) component, as a (D) component, were added and mixed by a planetary mixer at 25° C. for 30 minutes in the environment, and were cured at 50° C. for 3 days, and thus, a moisture curable resin composition of Example 1 was obtained. Note that, 100 parts by mass of the moisture curable resin composition obtained was filled in a sealed container (a laminated tube).

### Example 2

A moisture curable resin composition of Example 2 was obtained by the same preparation as that in Example 1, except that 0.2 parts by mass of the (c1) component was changed to 0.23 parts by mass of the (c1) component in Example 1.

### Example 3

A moisture curable resin composition of Example 3 was obtained by the same preparation as that in Example 1, except that 0.2 parts by mass of the (c1) component was changed to 0.4 parts by mass of the (c1) component in Example 1.

### Example 4

Example 4 that is A moisture curable resin composition of Example 4 was obtained by the same preparation as that in Example 1, except that 0.2 parts by mass of the (c1) component was changed to 0.45 parts by mass of the (c1) component, in Example 1.

### Comparative Example 1

A moisture curable resin composition of Comparative Example 1 was obtained by the same preparation as that in Example 1, except that 0.2 parts by mass of the (c1) component was changed to 0.01 parts by mass of the (c1) component in Example 1.

### Comparative Example 2

A moisture curable resin composition of Comparative Example 2 was obtained by the same preparation as that in Example 1, except that 0.2 parts by mass of the (c1) component was changed to 1.0 parts by mass of the (c1) component in Example 1.

### Comparative Example 3

A moisture curable resin composition of Comparative Example 3 was obtained by the same preparation as that in Example 4, except that the (c1) component was changed to zeolite (Molecular Sieve 3A, manufactured by Union Showa K.K.) having a pore diameter of 3 angstroms of a (c′1) component in Example 4.

### Comparative Example 4

A moisture curable resin composition of Comparative Example 4 was obtained by the same preparation as that in Example 1, except that the (c1) component was excluded in Example 1.

### Comparative Example 5

A moisture curable resin composition of Comparative Example 5 was obtained by the same preparation as that in Example 1, except that the (b1) component was changed to a bismuth-based catalyst of (b′1) (PUCAT B7) in Example 1.

A test method used in Examples and Comparative Examples of Table 1 is as follows.

<(1) Measurement of Initial Tack-Free Time>

Measurement was performed on the basis of a tack-free test of JIS A 1439:2016 by using the moisture curable resin composition of Examples and Comparative Examples immediately after being manufactured (the moisture curable resin composition before a storage stability test) in an environment of 23° C. and 50% RH.

Specifically, the moisture curable resin composition is applied onto a polyethylene sheet with a beat having Width 10 mm×Thickness 1 mm×Length 50 mm, and the surface of the moisture curable resin composition was lightly touched with a toothpick. A time from when the moisture curable resin composition was applied to when it was determined that the surface was cured without being attached to the toothpick was evaluated as a “tack-free time (minute)”. It is preferable that the tack-free time is longer than or equal to 3 minutes and shorter than 15 minutes, from the viewpoint of workability.

<(2) Measurement of Tack-Free Time after Storage Stability Test>

Measurement was performed on the basis of a tack-free test of JIS A 1439:2016, in an environment of 23° C. and 50% RH, by using the moisture curable resin composition of Examples and Comparative Examples after a storage stability test (the moisture curable resin composition stored for 7 days in an environment of a high temperature of 70° C.)

Specifically, the moisture curable resin composition is applied onto a polyethylene sheet with a beat having Width 10 mm×Thickness 1 mm×Length 50 mm, and the surface of the moisture curable resin composition was lightly touched with a toothpick. A time from when the moisture curable resin composition was applied to when it was determined that the surface was cured without being attached to the toothpick was evaluated as a “tack-free time (minute)”. It is preferable that the tack-free time is longer than or equal to 3 minutes and shorter than 15 minutes, from the viewpoint of workability.

<(3) Storage Stability Evaluation>

The value of tack-free time of the moisture curable resin composition before a storage stability test was set to an initial tack-free time, the value of tack-free time of the moisture curable resin composition after a storage stability test was set to a tack-free time after storage, and storage stability was evaluated by the value of “Tack-Free Time after Storage/Initial Tack-Free Time×100(%)”, on the basis of the following criteria. Note that, it is preferable that the tack-free time is not greatly different before and after storing the moisture curable resin composition.

### [Evaluation Criteria]

Acceptable: less than 140%

Unacceptable: greater than or equal to 140%

TABLE 1

| | Initial | Tack-free time | Storage |
|---|---|---|---|
| | tack-free | after storage stability | stability |
| | time (minute) | test (minute) | evaluation (%) |
| Example 1 | 4 | 4 | 100% |
| Example 2 | 4 | 5 | 129% |
| Example 3 | 4 | 5 | 125% |
| Example 4 | 5 | 6 | 122% |
| Comparative | 1 | 3 | 250% |
| Example 1 | | | |
| Comparative | 9 | 22 | 259% |
| Example 2 | | | |
| Comparative | 3 | 7 | 233% |
| Example 3 | | | |
| Comparative | 1 | 1 | 100% |
| Example 4 | | | |
| Comparative | 13 | 30 | 231% |
| Example 5 | | | |

According to Examples 1 to 4 of Table 1, it is found that the present invention can provide a moisture curable resin composition that is capable of making the initial moisture curing properties appropriately excellent in the workability and the moisture curing properties after a storage stability test compatible.

In addition, Comparative Example 1 of Table 1 is the moisture curable resin composition in which the content of the (C) component characterized by the present invention is less than the range defined in the present invention, and in Comparative Example 1, it was found that both of the initial tack-free time and the tack-free time after a storage stability test were excessively fast, and thus, the workability was degraded. In addition, Comparative Example 2 is the moisture curable resin composition in which the addition amount of the (C) component characterized by the present invention is greater than the range defined in the present invention, and in Comparative Example 2, it was found that the tack-free time after a storage stability test was slow, and thus, the storage stability was degraded. In addition, Comparative Example 3 is the moisture curable resin composition using zeolite having a pore diameter of 3 angstroms of the (c′1) component that is not the characteristic of the present invention of (C) component, and in Comparative Example 3, it was found that the tack-free time after a storage stability test was slow, and thus, the storage stability was degraded. In addition, Comparative Example 4 is the moisture curable resin composition not containing the (C) component characterized by the present invention, and in Comparative Example 4, it was found that both of the initial tack-free time and the tack-free time after a storage stability test were excessively fast, and thus, the workability was degraded. In addition, Comparative Example 5 is the moisture curable resin composition using the bismuth-based catalyst of the (b′1) that is not the (B) component of the present invention, and in Comparative Example 5, both of the initial tack-free time and the tack-free time after a storage stability test were excessively slow, and thus, the workability was degraded, and the storage stability was degraded.

Further, a test for a hardness, an elongation rate, a tensile strength, a tensile shear adhesive strength with respect to an acrylic resin, and a tensile shear adhesive strength with respect to aluminum of a cured product was performed.

(4) Measurement of Hardness

The thickness of the moisture curable resin composition of Example 1 was set to 1 mm, and was left to stand for 7 days in an environment of 23° C. and 50% RH, and thus, a cured product was obtained. A pressurization surface of an A-type durometer hardness tester (JIS-A) was pressurized with a force of 10 N while being retained in parallel to a test piece (in a state in which six sheet-like cured products were stacked to have a thickness of 6 mm), and the pressurization surface and the test piece were closely attached to each other. A maximum value is read out at the measurement, and the maximum value is set to a “hardness”. The details follow JIS K 6249(2003). Note that, in the present invention, it is preferable that the hardness is in a range of 5 to 90. As a result of the measurement, the hardness of the cured product of the moisture curable resin composition of Example 1 was 43.

(5) Measurement Method of Elongation Rate and Tensile Strength of Cured Product

The thickness of the moisture curable resin composition of Example 1 was set to 2 mm, and was left to stand for 7 days in an environment of 23° C. and 50% RH, and thus, a cured product was obtained. A test piece in the shape of a dumbbell No. 3 was cut out from a plate-like cured product. An interbaseline distance of the test piece was set to 25 mm, the test piece was pulled at 500 mm/min by a tensile tester, the interbaseline distance until the test piece in the shape of a dumbbell was fractured was measured, and (Interbaseline Distance at Fracture−Initial Interbaseline Distance)/Initial Interbaseline Distance×100 was calculated, as an “elongation rate (%)”, and a “tensile strength (MPa)” was obtained from a maximum strength of the dumbbell. The details are based on JIS K 6249:2003. Note that, in the present invention, it is preferable that the elongation rate is greater than or equal to 20%, and it is preferable that the tensile strength is greater than or equal to 1.7 MPa. As a result of the measurement, the elongation rate of the cured product of the moisture curable resin composition of Example 1 was 185%, and the tensile strength of that was 4.9 MPa.

(6) Measurement of Tensile Shear Adhesive Force with Respect to Aluminum

An aluminum member having Width 25 mm×Length 100 mm×Thickness 1 mm was used, and two aluminum members were pasted and fixed to each other with an adhesive area of 10 mm×25 mm by the moisture curable resin composition of Example 1. The moisture curable resin composition was cured by being left to stand for 7 days in an environment of 23° C. and 50% RH, and thus, a test piece was obtained. The test piece was pulled at 50 mm/min by a tensile tester, and a “tensile shear adhesive force (MPa)” was calculated from a maximum strength. The details are based on JIS K 6249:2003. Note that, in the present invention, it is preferable that a tensile shear adhesive force with respect to aluminum is greater than or equal to 1.5 MPa. As a result of the measurement, the tensile shear adhesive force with respect to aluminum of the cured product of the moisture curable resin composition of Example 1 was 5.3 MPa.

(7) Measurement of Tensile Shear Adhesive Force with Respect to Acrylic Resin

An acrylic resin member having Width 25 mm×Length 100 mm×Thickness 2 mm was used, and two acrylic resin members were pasted and fixed to each other with an adhesive area of 10 mm×25 mm by the moisture curable resin composition of Example 1. The moisture curable resin composition was cured by being left to stand for 7 days in an environment of 23° C. and 50% RH, and thus, a test piece was obtained. The test piece was pulled at 50 mm/min by a tensile tester, and a “tensile shear adhesive force (MPa)” was calculated from a maximum strength. The details are based on JIS K 6249:2003. Note that, in the present invention, it is preferable that a tensile shear adhesive force with respect to an acrylic resin is greater than or equal to 1.5 MPa. As a result of the measurement, the tensile shear adhesive force with respect to an acrylic resin of the cured product of the moisture curable resin composition of Example 1 was 3.2 MPa.

The present invention is a moisture curable resin composition that is capable of making initial moisture curing properties appropriately excellent in workability and moisture curing properties after a storage stability test compatible, and thus, the moisture curable resin composition of the present invention can be used in various adhesive agents and sealing applications, and is industrially useful.

What is claimed is:

1. A moisture curable resin composition, containing (A) to (C) components described below, wherein the moisture curable resin composition contains 0.03 parts by mass to 0.9 parts by mass of the (C) component with respect to 100 parts by mass of the (A) component.
(A) Component: a curable resin that has a main chain skeleton containing polyoxyalkylene and has a hydrolyzable silyl group
(B) Component: a moisture curing catalyst containing a fluorine-based compound
(C) Component: zeolite having a pore diameter of 5 angstroms to 30 angstroms

2. The moisture curable resin composition according to claim 1, wherein a hydrolyzable silyl group of the (A) component is an alkoxysilyl group.

3. The moisture curable resin composition according to claim 1, wherein a curable resin of the (A) component has urethane bonding on a main chain.

4. The moisture curable resin composition according to claim 1, wherein a viscosity of a curable resin of the (A) component at 25° C. is in a range of 5 Pa·s to 1000 Pa·s.

5. The moisture curable resin composition according to claim 1, wherein the moisture curable resin composition does not substantially contain an organic tin compound.

6. The moisture curable resin composition according to claim 1, wherein the (B) component is a complex containing boron trifluoride.

7. The moisture curable resin composition according to claim 1, wherein the (B) component is a boron trifluoride amine complex.

8. The moisture curable resin composition according to claim 1, wherein a content of the (B) component is 0.01 parts by mass to 0.9 parts by mass with respect to 100 parts by mass of the (A) component.

9. The moisture curable resin composition according to claim 1, further containing a silane compound having a hydrolyzable functional group, as a (D) component.

10. The moisture curable resin composition according to claim 1, further containing an inorganic filler, as an (E) component.

11. The moisture curable resin composition according to claim 1, wherein the moisture curable resin composition is used as an adhesive agent or a sealing agent.

12. A cured product in which the moisture curable resin composition according to claim 1 is cured.
